(19) United States
(12) Patent Application Publication
(10) Pub. No.: US 2006/0294584 A1
(43) Pub. Date: Dec. 28, 2006

(54) Auto-Configuration of Network Services Required to Support Operation of Dependent Network Services

(75) Inventor: Mohan Sundaram, Bangalore (IN)

Correspondence Address: LAW FIRM OF NAREN THAPPETA, C/O LANDON IP, INC., 1700 DIAGONAL ROAD, SUITE 450, ALEXANDRIA, VA, 22314, US

(73) Assignee: NetDevices, Inc., Sunnyvale, CA (US)

(21) Appl. No.: 11/161,459

(22) Filed: Aug. 4, 2005

(30) Foreign Application Priority Data
Jun. 22, 2005 (IN) 773/CHE/2005

(51) Int. Cl. G06F 15/16

(52) U.S. Cl. 726/11

(57) ABSTRACT

Auto-configuration (i.e., without requiring manual intervention) of network services required to support operation of dependent network services. For example, when an administrator causes instantiation of (or installs) OSPF protocol, the firewall, QoS and NAT services are automatically configured. Due to such configuration, the deployment of additional services may be simplified.

### RELATED APPLICATIONS(S)

The present application is related to and claims priority from the co-pending India Patent Application entitled, “Auto-Configuration of Network Services Required to Support Operation of Dependent Network Services”, Serial Number: 773/CHE/2005, Filed: 22-Jun-05, naming the same inventors as in the subject patent application, and is incorporated in its entirety herewith.

### BACKGROUND OF THE INVENTION

1. Field of the Invention

The present invention relates generally to devices used in Internetworking environments, and more specifically to a method and apparatus for auto-configuration of network services required to support operation of dependent network services.

2. Related Art

An inter-networked environment generally contains several devices which provide corresponding network services. Network services generally refer to services which operate at the lower layers to enable network applications to communicate with each other in the inter-networked environment.

Thus, environments often contain a router which provides a routing service. The routing service generally entails communicating with other routers to determine a routing table (indicating the direction in which each packet is to be forwarded). The routing table is then used to forward each received packet.

Firewall is another example of a network service, which generally is designed to allow only desired packets from entering/exiting into/from a network. The firewall service can be provided as a separate device or integrated into routers, noted above.

Network address translation (NAT) is an example of yet another network service, which is designed to translate a locally valid IP address to a globally (or in a domain at the other end of a network connection) valid IP address. The NAT service is generally integrated into routers noted above.

There are several network services which are dependent on other network services for proper operation. For example, OSPF (open shortest path first) requires that packets related to OSPF network protocol be forwarded (or permitted to enter/exit), in addition to packets destined/originating to/from the loopback address of the network device executing OSPF protocol.

Further, the other routers participating in OSPF may require that the IP packets be received with the loopback address as the source IP address. In other words, it may be desirable not to perform NAT operation for the packets with the loopback address. For further details on OSPF, the reader is referred to RFC 2328 entitled “OSPF Version 2”, dated April 1998.

Accordingly, at least when NAT and firewall services are used in an Inter-networked environment, proper operation of OSPF (dependent service) would require appropriate configuration of NAT and firewall services. Such configurations present particular challenges at the time of deployment (or addition) of the services, for example, when new equipment is being added to the network.

In one prior embodiment, an administrator is required to manually configure NAT and firewall services when OSPF is enabled for operation. In general, manual configurations are undesirable both due to the overhead as well exposure to human/manual errors. In addition, manual approaches may not provide for any desirable (timely) reconfiguration in case of service outages since service outages themselves may not be detected instantly/ immediately after the occurrence of the outage.

In another prior embodiment described in US Patent Publication Number US2003135596 (naming Moyer et al as inventors and entitled, “Network configuration management”) having a Publication date of 2003-07-17, a network configuration manager is disclosed as a separate physical unit from gateways implementing network services such as NAT, Firewall, DHCP, VPN, and router.

The network manager is described as being invoked manually or automatically upon a detection of traffic for a new service being used in a network. However, the configuration appears to be performed on the new/same service for which a need is detected. The need is described as being detected, for example, when a user attempts to configure the (same) service, when packets on a network indicate that the (same) service is required, or if an external system generates a request to the network configuration manager to configure the network for the same service when a user tries to access the service from the external system.

However, at least in situations such as in the case of dependent services described above, there is a general need for auto-configuration of network services required to support addition of dependent network services.

### BRIEF DESCRIPTION OF THE DRAWINGS

The present invention will be described with reference to the accompanying drawings, which are described below briefly. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an example environment in which various aspects of the present invention can be implemented.

FIG. 2 is a flow chart illustrating the manner in which a network device operates to configure network services required to support operation of dependent network services in an embodiment of the present invention.

FIG. 3 is a block diagram illustrating the details of a network device in another view.

FIG. 4 is a block diagram illustrating the details of a software architecture of a network device to configure network services in one embodiment.

FIG. 5 is a block diagram illustrating the details of processing of packets by network services executing in a network device in one embodiment.

FIG. 6 is a block diagram illustrating the details of an embodiment of a digital processing system in which various aspects of the present invention are operative by execution of appropriate software instructions.

### DETAILED DESCRIPTION OF THE PREFERRED EMBODIMENTS

1. Overview and Discussion of the Invention

According to an aspect of the present invention, network services required to support operation of dependent network services are auto-configured (i.e., without requiring human intervention). For example, when an administrator causes instantiation of (or installs) OSPF protocol, the firewall and NAT services are automatically configured. Due to such configuration, the deployment/support of additional services may be simplified.

According to another aspect of the present invention, the network services and the hardware/ software causing auto-configuration are all implemented in the same physical unit. By integration in such a single physical unit, the configurations may be performed reliably. 30

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

2. Example Environment

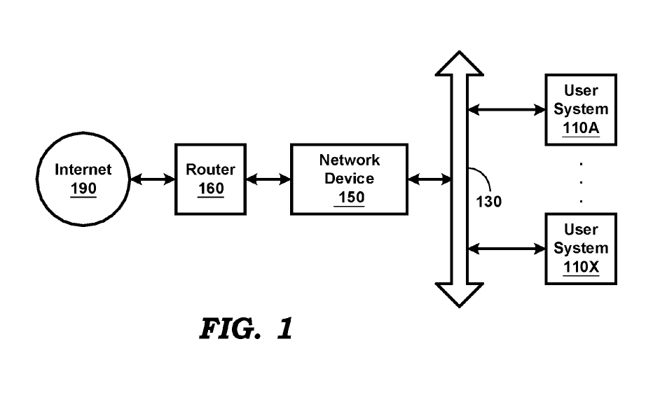

FIG. 1 is a block diagram illustrating the details of an example environment in which various aspects of the present invention can be implemented. The environment is shown containing user systems 110A-110X, local-area-network (LAN) 130, network device 150, router 160 and Internet 190. It is assumed that user systems 110A-110X, local-area-network (LAN) 130 and network device are located within an enterprise and router 160 is located on the premises of an Internet Service Provider. Each block is described in further detail below.

Internet 190 provides access to various other systems available on the world-wide-web. The systems in the enterprise access the world-wide-web through router 160. Router 160 needs to be implemented consistent with the design of network device 150.

User systems 110A through 110X represent systems such as client machines and server machines, typically present in enterprise networks. 130 provides connectivity to the systems within the enterprise, as well as to network device 150, which facilitates connectivity to the external networks.

Network device 150 implements various services which are dependent on configuration of other services for proper operation. Various aspects of the present invention simplify the deployment/use of the services, as described below in further detail.

3. Simplifying Use/Support of Services

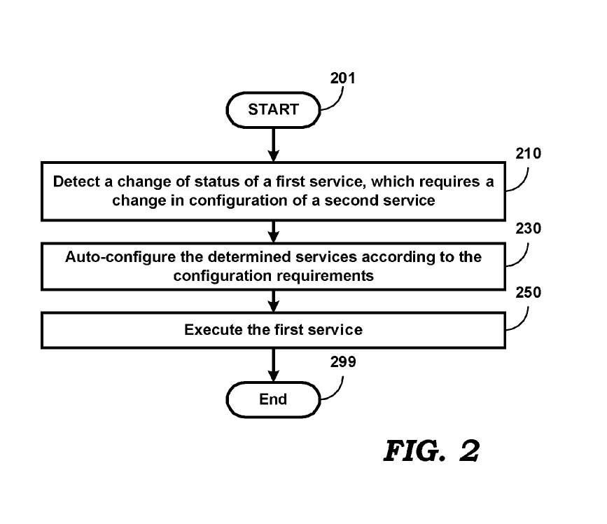

FIG. 2 is a flowchart illustrating the manner in which various aspects of the present invention simplify support of the services which require configuration of other services. The description is provided with respect to FIG. 1 merely for illustration. However, the flowchart can be implemented in other systems and environments, without departing from the scope and spirit of various aspects of the present invention. The flowchart begins in 201, in which control passes to step 210.

In step 210, a change of status of a first service, which requires a change in the configuration of a second service, is detected. The change of status corresponds to enabling (indication of start of execution or already executing) of a service and disabling (shutting down or termination) of a service. For example, when IPSec service is enabled, NAT and firewall may require reconfiguration as described above. On the other hand, when the IPSec service is disabled, some of the changes may need to be reversed. For illustration, the description is continued assuming the first service is enabled (after installation and configuration).

In step 230, the identified services are auto-configured according to the configuration requirements (dependency) of the first service. As noted above, auto-configuration refers to automatic (without additional related manual intervention) configuration. Such auto-configuration may be implemented by appropriate design of software instructions implemented within network device 150, as described in sections below with examples.

In step 250, the first service is executed (or execution is continued). Due to the change of configuration of the second service, the first service executes, as desired. The flowchart ends in step 299.

While the description is provided substantially with respect to a scenario in which the first service is executed, it should be appreciated that the auto-configuration of step 230 can be performed even in scenarios is which the execution of the first service is terminated (change in status of the first service), and the configuration performed for execution is reversed (undo). As a result, a present configuration of network devices may precisely correspond to the requirements of only presently executing services.

Due to the auto-configuration of step 230, the first service may operate as desired. The auto-configuration also minimizes the overhead and errors, as can be readily appreciated. The approach(es) described above can be implemented in various embodiments employing different architectures. Example architectures providing several features of the present invention are described below in further detail.

4. Hardware Architecture of Network Device

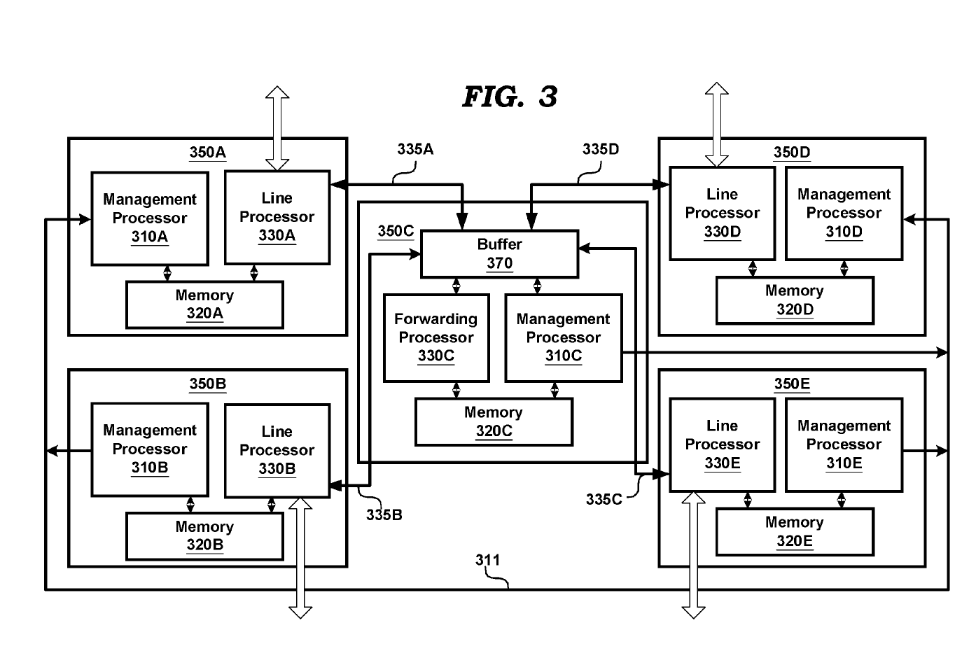

FIG. 3 illustrates the details of network device 150 in one embodiment. Network device 150 is shown containing management processors 310A-310E, management memories 320A-320E, line processors 330A, 330B, 330D, and 330E, forwarding processor 330C, and buffer 370. The management processors are shown connected by management bus 311, and line processors 330A, 330B, 330D and 330E are shown connected via forwarding processor 330C.

Each pair of a management processor and forwarding processor may be contained in a corresponding card. Thus cards 350A, 350B, 350D and 350E are respectively shown containing {management processor 310A and line processor 330A}, {management processor 310B and line processor 330B}, {management processor 310D and line processor 330D},{management processor 310E and forwarding processor 330E}. Thus, forwarding of packets across cards occurs via card 350C (and is referred to as a main processing system), while buffer 370 is used to store packets between the forwarding operations.

In an embodiment, forwarding processor is implemented using Opteron (TM) processor available from Advanced Micro Devices Inc., One AMD Place, Sunnyvale, Calif. 94088, Phone: (408) 749-4000, each management processor is implemented using IXP processor available from Intel Corporation, and the line processor depends on the specific type of connection (e.g., Mindspeed corporation for T1 interface, Marvel Corporation for Ethernet). The management processors are shown connected by Ethernet bus 311, while the line processors are connected to forwarding processor 330C by corresponding PCI Express Interface (335A-335D), well known in the relevant arts.

Broadly, each line processor may receive data to be routed/switched on a corresponding interface(s) (e.g., T3, Ethernet, etc. as shown by corresponding bidirectional path), and stores the corresponding packet in buffer 370. Forwarding processor 330C determines the specific line card on which to forward each packet stored in buffer 370. The forwarding decisions are generally based on various forwarding tables (e.g., routing table in the case of IP). Each packet is then transmitted by the corresponding line processor.

Management processors 310A-310E facilitate the management of various services (e.g., by executing the feature servers, described in detail below) and hardware, as well as setting up some of the tables used by forwarding processors. However, broadly, management processors 310A-310E provide various management features, health monitoring of services, notification, time stroke alerts, logging, etc., (requiring high reliability).

Only the details of management/line/forwarding processors as relevant to an understanding of the features of the present invention are described in detail in this document. For further details, the reader is referred to co-pending U.S. patent applications bearing Ser. No.:10/950253, entitled, ‘System and Method for Enabling Management Functions in a Network’, filed: Sept. 24, 2004 and Ser. No.: 11/060199, entitled, ‘System and Method for Enabling Redundancy in PCI-Express Architecture’, filed: Feb. 17, 2005, (both having the assignees of the subject application as a common assignee) which are both incorporated in their entirety herewith.

As relevant to the present application, management processors 310A-310E operate to provide processes which store critical configuration data, as described below with reference to a software architecture.

5. Example Software Architecture

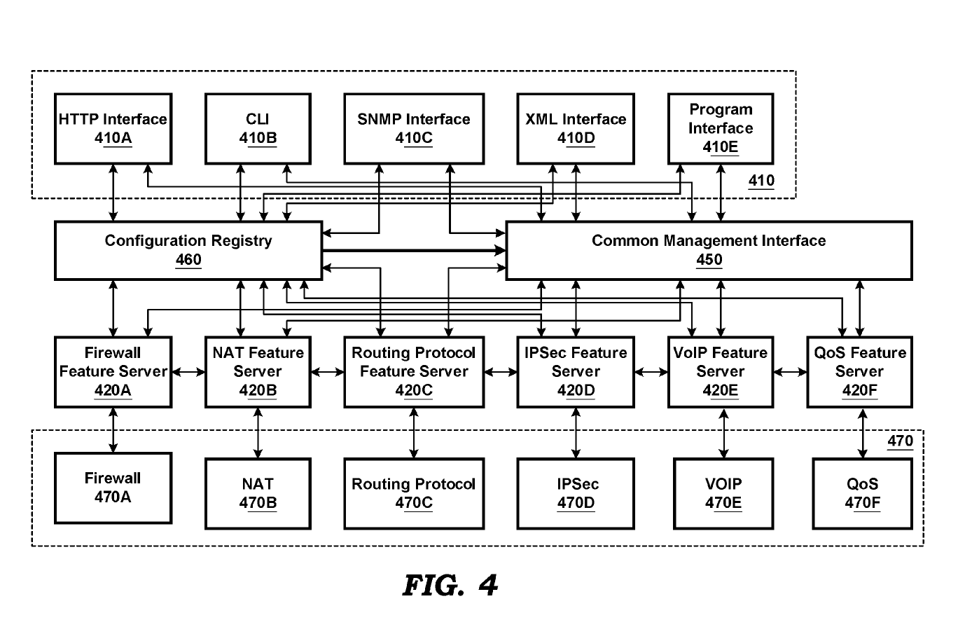

FIG. 4 is a block diagram illustrating the details of an example software architecture for network device 150 to provide various features of the present invention. The block diagram is shown with four logical layers—command layer, intermediate layer, feature server layer, and services layer. Each layer is described below in further detail.

The command layer is shown containing HTTP graphical user interface (GUI) 410A, command line interface (CLI) 410B, SNMP interface 410C, extended meta language (XML) interface 410D and program interface 410E. The services layer is shown containing firewall 470A, network address translation (NAT) 470B, routing protocol 470C, IPSec 470D, voice over IP (VOIP) 470E, and QoS 470F. The feature server layer is shown containing firewall feature server 420A, NAT feature server 420B, routing protocol feature server 420C, IPSec feature server 420D, VolP feature server 420E, and QoS Feature Server 420F. The intermediate layer is shown containing configuration registry 460 and common management interface (CMI) 450.

Broadly, the services in the service layer and forwarding of packets is implemented using processors 330A-330E. Configuration registry 460 is supported by in-memory database stored in memory 320C (while information specific to each line processor may be stored in corresponding local memory 320A, 320B, 320D and 320E), and feature servers 420A-420F are executed in management processors 310-310E for high reliability. Each block is described below in further detail.

The blocks in the command layer provide corresponding interfaces using which each service can be managed (configured, enabled, disabled, monitored, etc.). Thus, HTTP GUI 410A enables a web-based client to manage the services using web pages. CLI 410B enables management using commands provided by a command line interface (e.g., from a keyboard). SNMP interface 410C and XML interface 410D respectively enable management using commands by SNMP protocol and XML specified commands. Program interface 410E enables management commands to be issued from programs. The implementation of all such blocks in command layer will be apparent to one skilled in the relevant arts based on the specific designs chosen for the CMI and/or services.

Configuration registry 460 provides a database of data elements (“configuration data”) required for configuration of the various services. The data elements may be stored according to any convenient convention such that the information can be identified appropriately with the corresponding feature of the service. In general, configuration registry 460 is updated to the desired values irrespective of whether the corresponding service is executing then or not. As a result, when a service is initialized, the corresponding service can be configured according to the data in configuration registry 460. In addition, the data indicates the specific service causing the corresponding configuration such that the configuration can be reversed when the specific service is not executing (as described in further detail in sections below).

Feature servers 420A-420F triggers (initiates) reconfiguration of services (automatically) according to various aspects of the present invention. Thus, when a first service is initiated (or starts execution), the feature server is designed to interface with other feature servers to cause the desired reconfiguration. Similarly, when the first service terminates (either normally or abnormally), the feature server detects the corresponding change of status, and reverse the earlier effected configurations (due to the start of execution of the first service).

To facilitate such features, each feature servers 420A-420F conveniently operate as ‘gatekeepers’ to data affecting the configuration of corresponding services. Thus, all requests to change configuration are routed through the feature server of the corresponding service. Accordingly, each feature server 420A-420F receives commands for configuration changes of corresponding service(s), and changes the data in configuration registry 460 if needed, in addition to interfacing with the corresponding service to effect the change immediately. The commands received may correspond to the management commands from various blocks in command layer 410 as well.

Communication between feature servers 420A-420F may be implemented using techniques such as inter-process communication using bus 311 as the physical medium. Feature servers 420A-420E may continue execution (or, are always active/alive) irrespective of the status of the corresponding service. Such a feature simplifies the desired auto-configuration as described in sections below. Each feature server may indicate by appropriate data in configuration registry 460 whether the corresponding service is presently executing or not.

CMI 450 provides an application programming interface (API) using which each of the services can be managed. The commands received by the various blocks in the command layer are translated and presented consistent with the interface requirements (e.g., procedure parameters, etc.) of each procedure (or method in object oriented language). Each procedure is generally designed to interface with specific feature server for a corresponding service and provide a corresponding management operation (e.g., configuration). CMI 450 validates any parameter values that may be provided by the administrator for execution of various commands received. CMI 450 may also enable the feature services to retrieve configuration data of interest, as described in sections below in detail.

The design and implementation of each procedure needs to be consistent with the implementation in the corresponding service, and several such implementations will be apparent to one skilled in the relevant arts. In addition, some general procedures (e.g, to query the presently operating list of services) may also be provided as needed to support the operation of various features. Some of the specific procedures required to support the features of the present invention will be clearer from the description in sections below.

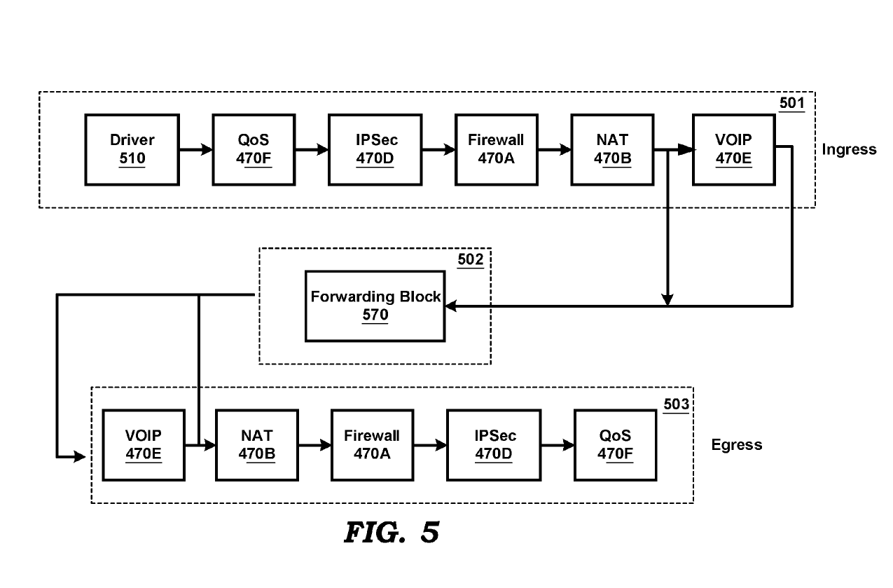

Firewall 470A, network address translation (NAT) 470B, routing protocol 470C, IPSec 470D voice over IP (VOIP) 470E, and QoS 470F represent various services which are executed in the forwarding processors of network device 150 in one embodiment. It should be appreciated that other services also may be supported/executed (in network device 150), some of which may need to be reconfigured for proper execution of other services, but are not described in the present application for conciseness. The manner in which these services process packets in an embodiment is described below with respect to FIG. 5.

6. Processing Packets by Services 64

FIG. 5 is a block diagram illustrating the manner in which packets are processed by various services in an embodiment of the present invention. As shown there, a packet is received in three phases—(1) ingress processing 501; (2) forwarding processing 502; and (3) egress processing 503. Each of the services may operate individually in both ingress processing and egress processing, and forwarding processing is shared by all the services together.

With respect to ingress processing 501, a packet received by driver 510 of a line processor is first processed by QoS service 470F. Packets requiring higher priority are marked accordingly (by QoS service 470F), and subsequent services process such packets with a higher priority. In this embodiment, it is assumed that there are only two priorities such that the higher priority packets (marked as such) are selected for processing ahead of other waiting packets by each subsequent service. The priority aspect is not described expressly in other services, as the corresponding processing may otherwise (i.e., other than sequence of selection) be the same for both high and low priority packets.

After QoS service 470F, each packet is processed by IPsec service 470D, firewall service 470A, and NAT service 470B, in that sequence. Then, packets related to VoIP are forwarded to VoIP block 470E, which provide various voice related features such as call management. The packets from VoIP block 470E are sent to forwarding block 570.

Each of these services may be implemented according to respective ‘functional’ requirements (generally well known in the relevant arts). Such implementation of each of the services is well known to one skilled in the relevant arts. The packets which are to be forwarded on different interfaces after desired Egress processing operations, are stored in forwarding buffer 370.

Forwarding processing 502 (forwarding block 570) determines the specific interface each packet in forwarding buffer 370 is to be forwarded on. The specific processor is generally determined based on routing/forwarding tables setup by routing protocol 470C. Once the specific processor/interface is determined, the packet is further processed by egress processing 503.

With respect to egress processing 503, the packets are again processed by NAT service 470B, firewall 470A, IPSec 470D, and QoS service 470F. QoS service 470F causes transmission of high priority packets in out-of-sequence (ahead of lower priority packets). Thus, by the operation of all these services cooperatively within network device 150, packets may be switched as desired.

However, proper operation of routing protocol 470C, IPSec 470D and voice over IP (VOIP) 470E requires appropriate configuration of NAT 470B, firewall 470A and QoS 470F. The manner in which such configuration is performed automatically is described in sections below.

7. Support for Routing Protocol

As noted above, routing protocols generally operate to fill/set the routing table, which is then used to forward packets. Open Shortest Path First (OSPF) is an example of such a routing protocol. Only the details of OSPF as relevant to various features of the present invention are described below briefly for conciseness. For further details on OSPF, the reader is referred to RFC 2328 entitled ‘OSPF Version 2’ dated April 1998.

For clarity, each (example) requirement of OSPF is noted, and the manner in which any other required services can be configured to meet the requirement is described.

OSPF is based on IP packets which have a PROTOCOL field in the IP header set to 89. Thus, when routing protocol feature server 420C detects start of execution of routing protocol 470C, routing protocol feature server 420C sends commands to firewall feature server 420A requesting configuration change to firewall service 470A. The configuration change is designed to permit IP packets with protocol value of 89 to be forwarded (on desired interfaces).

Upon receiving a request from routing protocol feature server 420C, firewall feature server 420A interfaces via CMI 450 (again consistent with the interface requirements) to change the configuration data in configuration registry 460. Configuration registry 460 may be designed to store data indicating that the specific entries are owned/created by routing protocol feature server 420C. In addition, firewall feature server 420A determines whether firewall service 470A is presently executing (for example, by examining registry 460), and causes the configuration to be effective immediately as well.

OSPF also requires that the packets destined/originating to/from network device 150 with a loopback address of the device not be NATed (i.e., address translation should be bypassed). Accordingly, routing protocol feature server 420C causes NAT feature server 420B to issue a command (consistent with the interface requirements of CMI 450) to bypass NAT if the source address of IP packets equals the loopback address of network device 150 with respect to packets being transmitted towards router 160. or also if the destination address of IP packets equals the loopback address.

Since NAT and firewall are auto-configured, the task of deployment of OSPF may be simplified. While the description above is provided with respect to OSPF for illustration, the approaches can be extended to other routing protocols also, as will be apparent to one skilled in the relevant arts by reading the disclosure provided herein.

8. Support for IPSec

As described in RFC 2411 entitled ‘IP Security Document Roadmap’ dated November 1998, IPSec provides secure connections over public networks (such as Internet). Broadly, Internet Key Exchange (IKE) protocol negotiates IPSec security associations (such as encryption strength) and then the authenticated header (AH) and Encapsulating Security Payload (ESP) protocols are used to provide the secure connections. The requirements of each of these and the manner in which these requirements is met, is described below.

With respect to IKE, the exchanges are based on UDP protocol on ports 500 and 4500. Accordingly, IPSec feature server 420D configures firewall 470A to forward UDP packets on ports 500 and 4500 by interfacing with firewall feature server 420A. Changes are effected in configuration registry 460 and also in firewall service 470A, if presently executing.

In addition, IKE uses a peer address (configured within IPsec 470D of network device 150) which is used in the negotiations. Accordingly, similar to in the OSPF case described above, it is desirable to bypass address translation of packets originating with IP address equaling the peer address as well as packets received with destination address equaling the peer address. IPSec feature server 420D may accordingly issue commands to effect the desired configuration changes to NAT 470B.

With respect to AH and ESP, the corresponding packets contain values of 50 or 51 in the protocol field in the IP header. Accordingly, IPSec feature server 420D may accordingly issue commands to firewall feature server 420A to cause firewall 470A to allow IP packets with protocol numbers 50 and 51. In addition, configuration changes are effected (in registry 460 as well as any presently executing NAT service) to bypass address translation of packets with 50 and 51 in the protocol field. As a result, the support requirements for IPsec may be automatically met by the auto-configurations thus performed.

9. Support for VoIP

VoIP (voice over IP) generally allows voice calls to be conducted using the IP infrastructure. A control connection is first established to setup the voice call on a data connection, and the voice call progresses on the data connection thereafter. The manner in which requirements of the two connection types may be met, is described below.

With respect to control connection, the corresponding packets contain a value of 47 in the protocol field of the IP header. Accordingly, VoIP feature server 420E may be designed to issue commands to configure firewall 470A to allow IP packets with a protocol number of 47 on desired interfaces (when VoIP 470E starts executing or is determined to be executing).

In addition, VoIP 470E may require that the packets on the control connection receive higher priority. Accordingly, VoIP feature server 420E may be designed to issue commands to QoS feature server 420F to configure QoS service 470F to cause the control packets to be provided high priority. While the description is provided with respect to control packets of VoIP, it should be appreciated that the higher priority may be provided to any other desired packets, as deemed necessary by specific service/application. With respect to data connection for VoIP, no configuration may be required.

Thus, the above description indicates the specific configurations that may need to be performed for each desired auto-configuration. The description is continued with respect to the manner in which auto-congfiguration may be caused be performed for IPSec, as described below.

10. Auto-configuration for IPSec

In an embodiment, matchlists are first caused to be stored in configuration registry 460. Appropriate queries may be sent via CMI 450 to retrieve the presently stored matchlists. If the desired match list is not already present, the matchlist may be stored first in configuration registry 460. Accordingly, the feature servers (in response to commands from IPSec 470D) may interface with CMI 450 to create the desired match list(s) in configuration registry 460. With respect to IPSec, the match list may be as follows, consistent with the description above:

Matchlist m1

| | |
|---|---|
| 50 | host IP1 host IP2 |
| udp | host IP1 host IP2 port 500 |
| udp | host IP2 host IP2port 4500 |
| 51 | host IP1 host IP2 |

Once the desired match lists are present in configuration registry 460, IPSec feature server 420D may define a filter containing all the desired match lists. The filter may be stored in configuration registry 460 by firewall feature server 420A. The filter may be as follows, consistent with the description above.

filter f1

1 match m1 allow

Once the desired filter is defined (as above), IPSec feature server 420D may apply the previously defined filter by interfacing with firewall feature server 420A. Assuming the filter is to be applied to interface GIGE 3/0, the following data illustrates the desired configuration, consistent with the description above.

interface GIGE 3/0

in filter f1

Thus, when IPSec 470D is initialized, IPSec feature server 420D causes filter f1 to be applied to interface GIGE 3/0, in addition to storing the corresponding information in configuration registry 460. Similar techniques can be used to specify high priority for desired packets (using QoS service 470F).

Thus, using the approaches such as described above, when the status of a service is enabled, any other required services are auto-configured, thereby facilitating the operation of the service, in addition to simplifying deployment of the service. Another aspect of the present invention reverses such configuration(s) when the status of the service changes to a disabled state (before termination), as described below.

11. Reversing Configuration Before Termination

Another aspect of the present invention reverses the configuration changes of services when the status of dependent services (IPSec, VoIP, etc.) changes to a disabled state. For conciseness the description is provided with respect to routing protocol 470C. However, configuration may be reversed in other cases also.

Routing protocol feature server 420C determines whether the status of routing protocol 470C is changed (or changing) to termination, and reverses the previously effected configuration. Routing protocol feature server 420C may query configuration registry 460 for all the changes caused due to routing protocol 470C, and interface with corresponding feature servers to reverse the configuration.

For example, with respect to packets with protocol field set to 89, routing protocol feature server 420C sends commands to firewall feature server 420A requesting that packets with protocol value of 89 can be blocked (or removal of the corresponding entry from active configuration data if the default firewall operation is to block). Similarly, routing protocol feature server 420C interfaces with NAT feature server 420B to stop NAT bypass of packets with loopback addresses in the destination/source address field.

Due to such reversal of configuration, unneeded processing/bypasses may be avoided, thereby enhancing the security features of network device 150.

It should be appreciated that the features described above may be implemented in various combinations of hardware, software and firmware, depending on the corresponding requirements. The description is continued with respect to an embodiment in which the features are operative upon execution of the corresponding software instructions.

12. Software Implementation

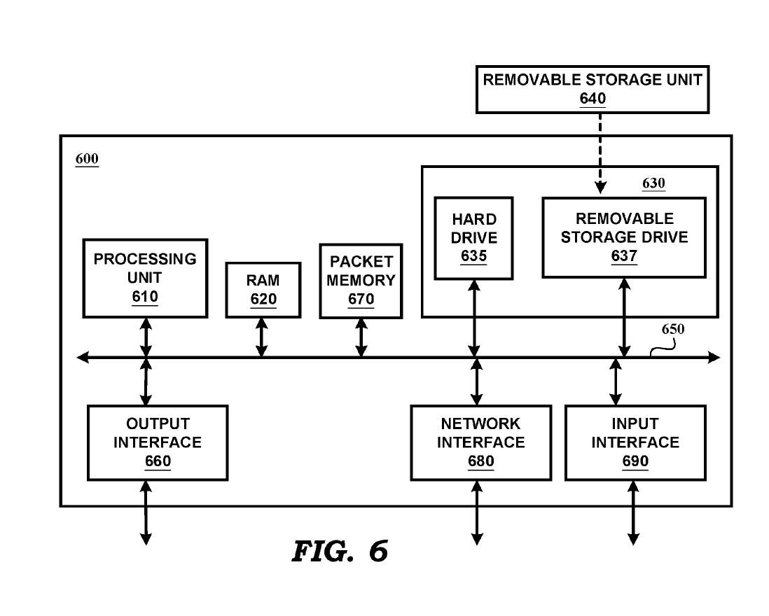

FIG. 6 is a block diagram illustrating the details of digital processing system 600 in one embodiment. System 600 may correspond to network device 150. System 600 is shown containing processing unit 610, random access memory (RAM) 620, secondary memory 630, output interface 660, packet memory 670, network interface 680 and input interface 690. Each component is described in further detail below.

Input interface 690 (e.g., interface with a key-board and/or mouse, not shown) enables a user/administrator to provide any necessary inputs (e.g., CLI 410) to system 600. Output interface 660 provides output signals (e.g., display signals to a display unit, not shown), and the two interfaces together can form the basis for a suitable user interface for an administrator to interact with system 600.

Network interface 680 may enable system 600 to send/receive data packets to/from other systems on corresponding paths using protocols such as internet protocol (IP). Network interface 680, output interface 660 and input interface 690 can be implemented in a known way.

RAM 620 (supporting memory 660), secondary memory 630, and packet memory 670 may together be referred to as a memory. RAM 620 receives instructions and data on path 650 (which may represent several buses) from secondary memory 630, and provides the instructions to processing unit 610 for execution.

Packet memory 670 stores (queues) packets waiting to be forwarded (or otherwise processed) on different ports/interfaces. Secondary memory 630 may contain units such as hard drive 635 and removable storage drive 637. Secondary memory 630 may store the software instructions and data, which enable system 600 to provide several features in accordance with the present invention.

Some or all of the data and instructions may be provided on removable storage unit 640 (or from a network using protocols such as Internet Protocol), and the data and instructions may be read and provided by removable storage drive 637 to processing unit 610. Floppy drive, magnetic tape drive, CD-ROM drive, DVD Drive, Flash memory, removable memory chip (PCMCIA Card, EPROM) are examples of such removable storage drive 637.

Processing unit 610 may contain one or more processors. Some of the processors can be general purpose processors which execute instructions provided from RAM 620. Some can be special purpose processors adapted for specific tasks (e.g., for memory/queue management). The special purpose processors may also be provided instructions from RAM 620.

In general, processing unit 610 reads sequences of instructions from various types of memory medium (including RAM 620, storage 630 and removable storage unit 640), and executes the instructions to provide various features of the present invention described above.

13. Conclusion

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method of providing services in a network device, said method comprising:
detecting a change of status of a first service to an enabled state, wherein said change of status requires a change in configuration of a second service for operation of said first service;
auto-configuring said second service according to said required change; and
executing said first service,
wherein said first service can operate due to said auto-configuring.

2. The method of claim 1, wherein said detecting is performed without waiting for packets generated by said first service on a network to which said network device is connected during operation.

3. The method of claim 1, wherein said detecting detects a change of status of said first service to a disabled state, wherein said auto-configuring reverses said change in said second service.

4. The method of claim 1, wherein said second service comprises at least one of a firewall, QoS and a network address translation (NAT).

5. The method of claim 4, wherein said first service, said second service and said auto-configuring are implemented in a single physical system.

6. The method of claim 5, wherein said auto-configuring comprises configuring said firewall to allow packets required for operation of said first service and configuring said NAT to bypass translating an address related to said first service.

7. The method of claim 6, wherein said configuring is implemented as software instructions outside of software instructions implementing said first service.

8. The method of claim 6, wherein configuration of said second service can be performed using commands issued by a plurality of access approaches, said method further comprising:
converting commands issued from all of said access approaches into a format consistent with the interface requirements of a common management interface (CMI), wherein commands are issued in said format to configure said second service,
wherein said auto-configuration is also performed by issuing commands according to said interface requirements of said CMI.

9. The method of claim 6, wherein said first service comprises OSPF routing protocol, and said auto-configuring configures said firewall to allow packets with a protocol field of IP header equaling 89, and said NAT to bypass translating packets originating with a source address equaling a loopback address configured for said OSPF routing protocol.

10. The method of claim 6, wherein said first service comprises IPSec, and said auto-configuring configures said firewall to allow UDP packets with port values equaling 500 and 4500, and also to allow packets with a protocol field of IP header equaling 50 and 51,
and auto-configuring further configuring said NAT to bypass translating packets originating with a source address equaling a peer address configured for network device operating as an end node of Internet Key Exchange (IKE) protocol.

11. The method of claim 6, wherein said first service comprises VoIP, and said auto-configuring configures said firewall to allow packets with a protocol field of IP header equaling 47.

12. The method of claim 6, further comprising:
providing a registry to store configuration data related to each of said first service and said second service;
providing a second feature server through which all commands to change configuration of said second service are routed, wherein a first feature server associated with said first service interfaces with said second feature server to cause said required change to be implemented in said registry.

13. A network device comprising one or more processors operable to:
detect a change of status of a first service to an enabled state, wherein said change of status requires a change in configuration of a second service for operation of said first service;
auto-configure said second service according to said required change; and
execute said first service,
wherein said first service can operate due to said auto-configuring.

14. A network device for providing services, said network device comprising:
means for detecting a change of status of a first service to an enabled state, wherein said change of status requires a change in configuration of a second service for operation of said first service;
means for auto-configuring said second service according to said required change; and
means for executing said first service,
wherein said first service can operate due to said auto-configuring.

15. A computer readable medium carrying one or more sequences of instructions for causing a network device to provide services in an inter-networked environment, wherein execution of said one or more sequences of instructions by one or more processors contained in said network device causes said one or more processors to perform the actions of:
detecting a change of status of a first service to an enabled state, wherein said change of status requires a change in configuration of a second service for operation of said first service;
auto-configuring said second service according to said required change; and
executing said first service,
wherein said first service can operate due to said auto-configuring.

16. The computer readable medium of claim 15, wherein said detecting is performed without waiting for packets generated by said first service on a network to which said network device is connected during operation.

17. The computer readable medium of claim 15, wherein said detecting detects a change of status of said first service to a disabled state, wherein said auto-configuring reverses said change in said second service.

18. The computer readable medium of claim 15, wherein said second service comprises at least one of a firewall, QoS and a network address translation (NAT).

19. The computer readable medium of claim 18, wherein said first service, said second service and said auto-configuring are implemented in a single physical system.
